(19) United States
(12) Patent Application Publication
(10) Pub. No.: US 2007/0136217 A1
(43) Pub. Date: Jun. 14, 2007

(54) Method and apparatus for remotely monitoring electricity rates

(76) Inventors: Peter Johnson, London (CA); Aldo Liberatore, London (CA)

Correspondence Address: BLAKE, CASSELS & GRAYDON LLP, BOX 25, COMMERCE COURT WEST, 199 BAY STREET, SUITE 2800, TORONTO, ON, M5L 1A9, CA

(21) Appl. No.: 11/442,313

(22) Filed: May 30, 2006

Related U.S. Application Data
(60) Provisional application No. 60/749,601, filed on Dec. 13, 2005.

(51) Int. Cl. G06F 17/00

(52) U.S. Cl. 705/412

(57) ABSTRACT

A system and method are provided for remotely capturing, processing and displaying spot electricity pricing information that enable a consumer to conveniently monitor market prices and use such information to determine when and how to consume electricity. A terminal is conveniently located within the residence of the consumer, and is preferably designed to be ergonomic in its human interface, as well as aesthetically pleasing. The terminal provides a convenient, intelligent and thus useful device so as to enable the consumer to take advantage of favourable spot pricing offered by an electricity supplier using data that has already been transmitted to a smart meter, or similar data provided by an independent entity.

This application claims priority from U.S. provisional patent application No. 60/749,601 filed Dec. 13, 2005.

### FIELD OF THE INVENTION

The present invention relates generally to data acquisition and data analysis and has particular utility in providing electricity pricing information to a consumer.

### DESCRIPTION OF THE PRIOR ART

Historically, both commercial and residential consumers have typically been charged a fixed or pre-set rate of a particular number of cents per kilowatt hour for the use of electrical energy. These fixed rates were generally determined, and set, based on an electrical distributor's ability to forecast its future costs, and its ability to set pricing through a local or regional authority.

In reality, a distributor's cost structure is subject to the fact that electricity is a commodity and as such, is typically subject to cyclic pricing. The price for electricity is influenced by many factors, including the price of the consumable commodity used to generate the electricity (e.g. coal, oil, uranium, etc), the cost of generating electrical energy, the costs associated with the transmission and distribution of the electricity, and the relationship between electricity generation capacity and demand, which typically translates to the time of day in which the electricity is used.

Traditionally, a major obstacle in pricing electricity, is that conventional metering technology and methods used by electrical distributors for metering electricity consumption, only report the amount of electricity that a particular consumer had used over a certain period of time (e.g. one month), whilst the cost of electricity can fluctuate significantly within that period of time. Such a billing scheme does not take into account at which time the electricity was consumed (e.g. at what time on what day of the month) or the price at which a unit of energy was sold at the time that the electricity was consumed (e.g. the particular price per kilowatt hour).

To overcome the above obstacle, electricity utilities have, and are continuously developing, “smart meter” technology, which measures data more frequently, in order to capture electricity consumption on a more frequent basis. Smart meters enable a distributor to employ variable pricing based on the instantaneous market price for electrical energy as it varies during a particular day during a particular month.

Technologies exist that can link a consumer's smart meter to a utility's accounting infrastructure. Typically, the information is transmitted either through “data over power” technology or by wireless methods. Data over power technology uses an existing power grid infrastructure to transmit data and is most often implemented for providing high-speed broadband Internet access to homes and businesses. This technology transmits data over the unused frequencies of the power lines since standard AC electricity is transmitted at a frequency of 50 Hz or 60 Hz and typically uses methods similar to those used for a digital subscriber line (DSL).

The principal benefit of smart meter technology is to encourage energy conservation, and this technology is intended to enable a consumer to conserve his or her consumption during peak and expensive time periods, in favour of usage during off-peak time periods. However, in order to make such decisions, the consumer must be aware of the market pricing, so that he or she can make an intelligent decision as to how and when to consume electricity. Instantaneous electricity pricing is commonly referred to as “spot” electricity pricing.

Currently, such spot pricing information is generally only available either through a display on the smart meter itself or by accessing a user account via the Internet. The smart meter may be placed in an inconvenient area of the home or business, and the display may be complicated in its presentation, and potentially difficult to read by persons with a disability, such as those confined to a wheel chair. Moreover, Internet access, although increasingly popular, may also be difficult or inconvenient for some consumers.

Accordingly, a convenient way of utilizing spot electricity pricing information that is beneficial to consumers is desired.

It is therefore an object of the present invention to obviate or mitigate the above identified disadvantages.

### SUMMARY OF THE INVENTION

A system and method are provided for remotely capturing, processing and displaying spot electricity pricing information that enable a consumer to conveniently monitor market prices and use such information to determine when and how to consume electricity.

In one aspect a display terminal is provided for providing electricity pricing information to a consumer. The terminal comprises a receiver for receiving data transmitted by an electricity supplier pertaining to said pricing information; a processor for analyzing said pricing information to determine to which one of a plurality of indicators said pricing information pertains; and a display for displaying said one of said plurality of indicators.

In another aspect a method is provided for providing electricity pricing information to a consumer. The method comprises the steps of receiving data transmitted by an electricity supplier pertaining to said pricing information; analysing said data to determine to which one of a plurality of indicators said pricing information pertains; and displaying said one of said plurality of indicators.

### BRIEF DESCRIPTION OF THE DRAWINGS

An embodiment of the invention will now be described by way of example only with reference to the appended drawings wherein:

FIG. 1 is a schematic of a system for monitoring and displaying electricity pricing information;

FIG. 2 is a schematic of the terminal shown in FIG. 1;

FIG. 3A is one embodiment of the display shown in FIG. 2;

FIG. 3B is another embodiment of the display shown in FIG. 2;

FIG. 4 is a flow chart illustrating a method for monitoring, processing and displaying electricity pricing information, and for controlling operation of the appliance shown in FIG. 1.

FIG. 5 is a flow chart illustrating a method of monitoring spot pricing using the terminal of FIG. 3A; and

FIG. 6 is a flow chart illustrating a method monitoring spot pricing and controlling the operation of an appliance using the terminal of FIG. 3B.

### DETAILED DESCRIPTION OF THE INVENTION

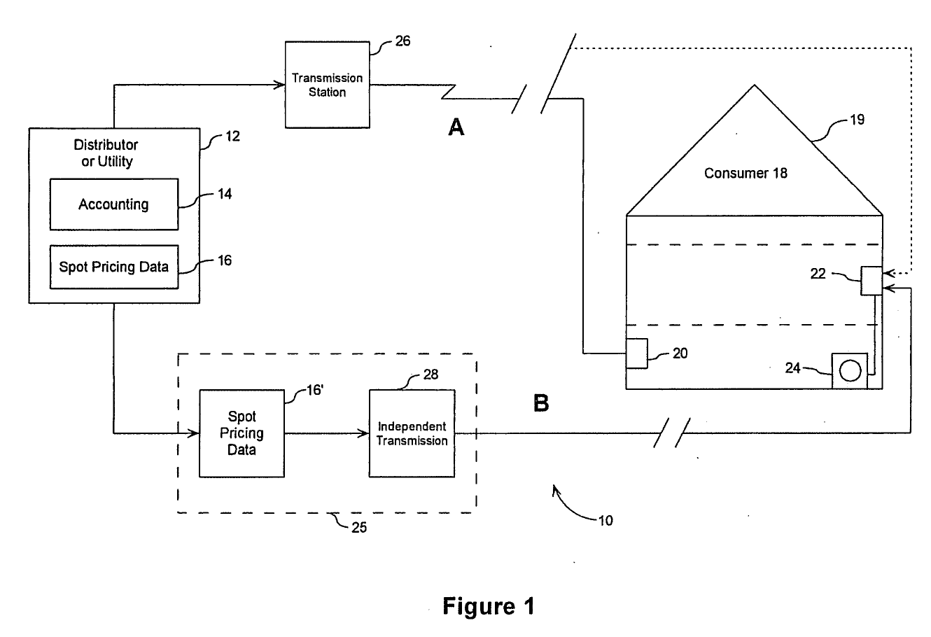

Referring therefore to FIG. 1, a system for monitoring, processing, and displaying spot electricity pricing information is denoted numeral 10. A utility or distributor, hereinafter referred to as a supplier 12, includes an accounting system 14, and a repository or database of spot pricing data 16 that is continually or periodically updated. A consumer 18 is provided with, and/or billed for, electricity distributed by the supplier 12. The consumer 18 has a smart meter 20 that is also typically provided by the supplier 12. The consumer 18 also has installed, in a convenient location within their residence 19, a display terminal 22. The display terminal 22 is preferably connected to one or more appliance 24 within their residence 19 for automatically and periodically controlling the operation of the appliance 24.

It will be appreciated that the terminal 22 may or may not be connected to an appliance 24, and may be connected to any number of appliances 24 if capable of such functionality. It will also be appreciated that the consumer 18 includes any customer of the supplier 12, e.g., commercial, residential or industrial establishments.

Although the terminal 22 is shown in FIG. 1 as a wall-mounted unit, it will be appreciated that the terminal 22 may also be designed as a wireless handheld unit or may be integrated into existing household electronics, a personal computer etc., and as such, should not be limited to the arrangement shown in FIG. 1. For example, the terminal 22 may be implemented as part of a circuit for an appliance 24 to control the operation thereof, or as a separate circuit that is installed with the existing electronics in order to control such automated functions.

In the exemplary system 10 shown in FIG. 1, two transmission channels for providing spot pricing information to the consumer 14 are shown, namely channel A and channel B.

Channel A represents a simplified transmission scheme directly connecting the supplier 12 to the consumer 18. In such a scheme, the supplier 12 provides spot pricing data 16 to the consumer 18 over channel A using a supplier-controlled transmission station 26. Preferably, the supplier 12 transmits the data over their existing power grid using data over power technology, and thus channel A represents such existing infrastructure. In channel A, data is sent in a usual manner to the consumer's smart meter 20, but is also transmitted directly to the terminal 22.

Channel B represents an alternative, independent transmission scheme for transmitting spot pricing data 16 indirectly to the consumer 18. In such a scheme, spot pricing data 16′ is in some way provided to an independent entity 25, e.g. through an Internet connection or other suitable medium. The entity 25 uses the data 16′ to arrange a transmission of data to the display terminal 22 using an independent transmission scheme 28. In the example shown in FIG. 1, the data 16′ is provided only to the terminal 22, however, if the entity 25 has a particular arrangement with the supplier 12, they may also provide data 16′ to the smart meter 20.

It will be appreciated that either or both channel A and channel B may utilize either wired or wireless transmission schemes and shall not be limited to any particular means of providing data to the terminal 22.

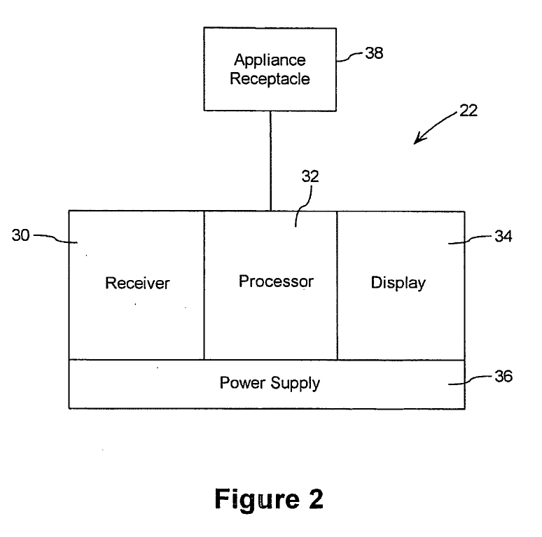

The terminal 22 is shown in greater detail in FIG. 2. The terminal 22 preferably includes a receiver 30 for receiving pricing data 16 or 16′, a processor 32 for analyzing and utilizing the data 16 or 16′ for providing useful data to the consumer 18, a display 34 for displaying such useful data to the consumer 18, and if capable of automatically controlling an appliance 24, the terminal 22 includes an appliance receptacle 38 for connecting the appliance 24 to the terminal 22. The receptacle 38 may be internal to the appliance (and thus the terminal 22 is itself internal to the appliance) or may be an external connection thereto. In this example, the above components are powered by a power supply 36.

The purpose of the receiver 30 is to capture a signal carrying the data 16 and 16′ that is transmitted from the transmission stations 26 and 28 by the supplier 12 and entity 25 respectively. Accordingly, the receiver 30 may receive the same data as the smart meter 20 (data 16), or similar data (data 16′) independent therefrom. Alternatively, the terminal 22 and the smart meter 22 may have a connection (not shown) therebetween such that the data provided to the smart meter 20 is shared with, and thus passed on, to the terminal 22 and vice versa. The receiver 30 provides the necessary hardware and software to acquire and interpret the data 16 and 16′ supplied by the supplier 12 and entity 25 respectively.

Preferably, the receiver 30 is compatible with the transmission format used by the supplier (e.g. wireless, data over power etc.); as well as the communication protocol chosen by the supplier 12. Once the data 16 or 16′ is captured, the receiver 30 awaits instructions from the processor 32 regarding how and when to present the captured data 16 or 16′. Therefore, the receiver 30 will typically have a buffer (not shown) to hold the data until it is required by the processor 32 or display 34. Alternatively, the receiver 30 may also store the received data in a memory device (not shown).

Since robust and efficient communication transmission with the smart meter 20 is preferable to the supplier's performance and profitability, it is preferable that the terminal 22 not interfere in any way with the integrity of the transmission. Therefore, in a preferred embodiment, the terminal 22 is designed to only receive data, and is not programmed to transmit or inject any signal, since such signals may degrade the performance of the original communication.

The processor 32 operates to control the receiver 30, interpret the data 16 and 16′ 4 captured by the receiver 30, and based on a set of rules, control the display 34. The rules include a set of internal criteria and computer implemented instructions for alerting the consumer I 8 to favourable and/or non-favourable usage periods using the display 34. For example, the rules may include a price range in which an electricity intensive appliance such as a clothes dryer should be used, but also a time period within the day that the dryer should not be used.

For instance, the dryer may be optimally used when prices are in a lower portion of the price range, but not between the hours of, e.g., 2 am and 5 am so as to not disrupt the consumer's sleep. These rules are used by the processor 32 to dictate what information is displayed for the consumer 18. In a preferable, but more sophisticated version of the terminal 22, the processor 32 can be used to turn on a built in outlet to power the appliance 24 during such an optimal period based on the particular rule set being applied.

It will be appreciated that the processor 32 may include any level of sophistication regarding the algorithms used for applying the rule set(s), and may employ any suitable software. The processor 32 may be a single microprocessor or a more sophisticated computing device as needed, based on the particular application. For example, in a more complex commercial or industrial application, greater computing power and more sophisticated software would likely be required, especially if several appliances and/or lighting systems are controlled by the terminal 22.

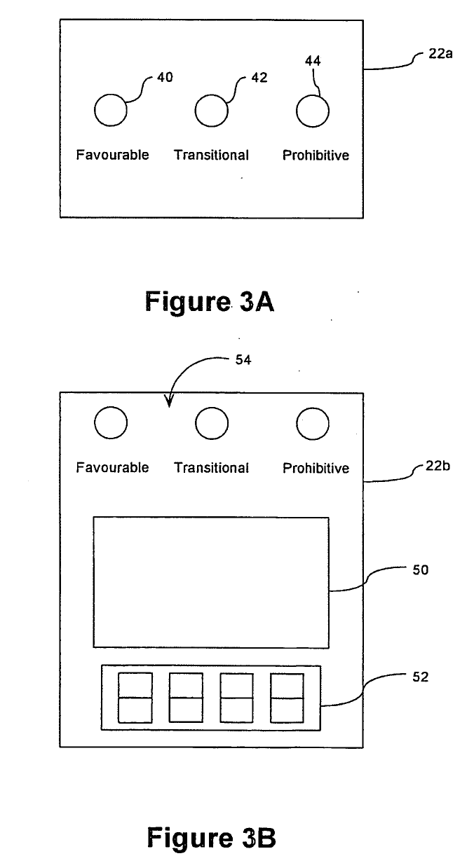

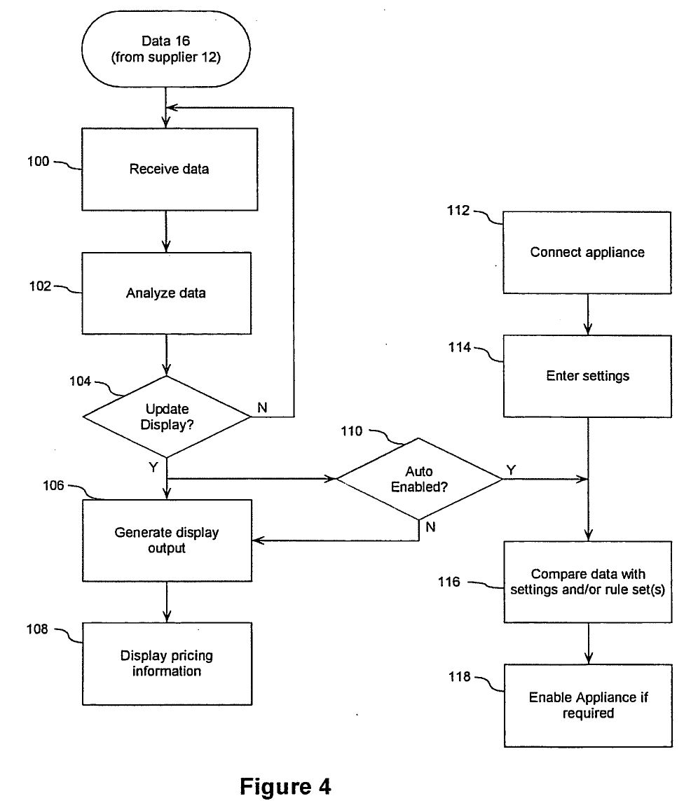

The display 34 is used to alert the consumer 18 of spot energy pricing. In one implementation of the terminal 22, the display 34 uses a plurality of indicators, such as coloured lights, preferably LEDs as shown in FIG. 3A. For example, three LEDs are used as follows. A green LED 40 would indicate that the price per kilowatt hour is within a favourable range (e.g. below a certain price), a yellow LED 42 would indicate a transitional range of price, and thus relatively higher pricing, and a red LED 44 would indicate a prohibitive range of prices, e.g. prices that may be above a certain level and thus perceivably “expensive”. In a more sophisticated embodiment as shown in FIG. 3B, the display 34 may employ, for example, a touchscreen 50, digital display 52, LEDs 54, or any combination thereof (note that all three are shown in FIG. 3B). A digital readout 52 or touchscreen 50 would enable the terminal 22 to specify the exact spot pricing in cents per kilowatt-hour, whilst the LEDs 54 may provide guidance as to the interpretation of the prices. The digital readout 52 may also provide guidance in the form of any suitable indicator such as a rating out of 10. A touchscreen 50 would also allow the consumer 18 to enter personalized settings for establishing rule sets and/or for connecting appliances 24. In yet another alternative, a single indicator (e.g. light or LED) may be used whereby if the indicator is “on”, pricing is considered to be favourable and if the indicator is “off”, the pricing is not considered to be favourable.

The power supply 36 may use electrical energy from the supplier 12 through a wall socket, or may be directly wired into the electrical system of the residence 29. Alternatively, the power supply 36 may use other sources of electricity (e.g. batteries or solar cells) to supply the components of the terminal 22, with, e.g., conditioned energy.

An example of the operation of the system 10 will now be described making reference to FIG. 3. FIG. 3 illustrates data 16 being supplied directly by the supplier 12, however, it will be appreciated that data 16′ may also be received indirectly through entity 25.

Data 16 originating from the supplier 12 and transmitted over channel A, using the transmission station 26, is received by the receiver 30 at step 100. At step 102, the processor 32 obtains the data 16 from the receiver 30 and analyzes the contents of the data 16, according to the rule set(s) programmed in the processor 32. At step 104, the processor 32, based on its analysis, determines whether or not a change in pricing has occurred. If there has not been any changes since it last received data 16, it may choose to not update the display 34 at this time, and instead, continue monitoring the data 16 received by the receiver 30. If the data has changed or is otherwise found to be pertinent, the processor 32 then generates the necessary display output at step 106, and updates the display 34 accordingly at step 108.

If the terminal 22 is capable of automatically monitoring data 16, the processor 32 will, between steps 104 and 106, also determine if the automatic monitoring is enabled at step 110. If the automatic monitoring is enabled, steps 112 and 114 would have preferably been pre-programmed in advance, by the consumer 18 or by the supplier 12. Step 112 includes connecting and configuring a particular appliance 24, and step 114 includes entering settings to develop the rule sets for automatically controlling the appliance 24. The processor 32 would then compare its analysis of the data 16 with the settings and/or rule sets programmed therein at step 116, and would then enable the appliance 24 at step 118. Enabling the appliance 24 may include modifying a setting, turning the unit “on” or “off” etc. Alternatively, the processor 32 may have default rule sets for common appliances such as dishwashers and dryers. In such an embodiment, the rule set will be automatically applied to the appliance 24 when connected/configured.

For example, if the appliance 24 is a dishwasher, and the processor 32 has determined that the pricing is optimal for running the dishwasher at that particular time, it may then turn the dishwasher on to employ a particular wash cycle. It will be appreciated that the processor 32 may control any number of functions of the appliance 24 beyond merely turning power “on” or “off”, such as adjusting the cycle settings, or the length of time it will run. It will be noted that the level of sophistication of the processor 32 and the automatic functions thereof are typically dictated by the level of sophistication of the terminal 22.

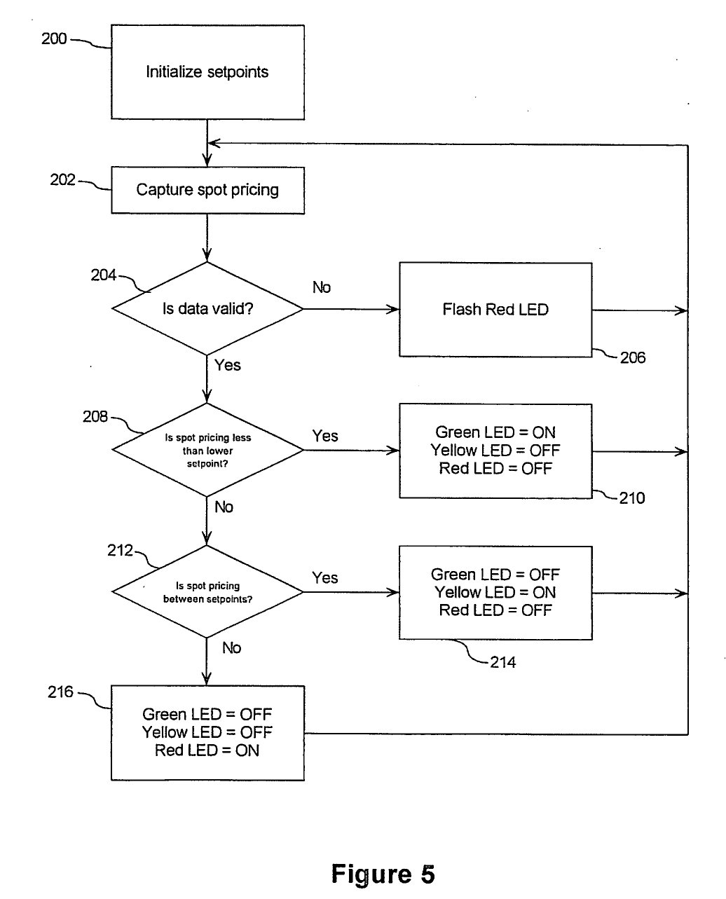

FIG. 5 provides an example of the operation of terminal 22a utilizing the LEDs 40-44 shown in FIG. 3A. This example illustrates the case where only pricing indicators are provided without there being a connection between the terminal 22a and the appliance 24.

For the terminal 22a to distinguish between favourable and non-favourable spot pricing, set points would be initialized at step 200. These setpoints can be programmed into the terminal by the consumer 18 or can be automatically generated and modified using historical data provided by the supplier 12. Optionally, the terminal 22a may receive information pertaining to particular price ranges with the data 16 or 16′, and update the setpoints accordingly. In this example, a low setpoint and a high setpoint are programmed into the terminal 22a.

At step 202 the terminal 22a begins monitoring electricity prices by capturing spot pricing data from data 16 or 16′. The data is checked for validity at step 204, typically by determining whether or not the price appears to be within a valid range or that it otherwise does not to appear to have been corrupted (e.g. if price appears to indicate $5,000 per kilowatt hour, data is invalid). If the data is invalid then Red LED is set to flash at step 206 which indicates to the consumer 18 that there is something wrong with the data.

If the data is valid, the processor 32 will then determine if the spot pricing is lower than the low setpoint at step 208, and if so, the green LED 40 is switched “on” while the yellow LED 42 and red LED 44 are switched “off” at step 210. This indicates that the price is favourable. If the spot pricing data is above the low setpoint, the processor next determines whether it lies between the low setpoint and high setpoint at step 212. If the price falls within this range, this indicates that the price is transitional, and the green LED 40 and red LED 44 are switched “off” and the yellow LED 42 is switched “on” at step 214.

If the spot pricing is higher than the high setpoint, then the processor 32 determines that the pricing is not favourable, and switches the red LED 44 “on”, and the green LED 40 and yellow LED 42 “off” at step 216. The terminal 22a is thus set to indicate one of the three states, and the processor 32 continues monitoring by returning to step 202. If new setpoints are required, then the process would start over from step 200 with a new initialization step.

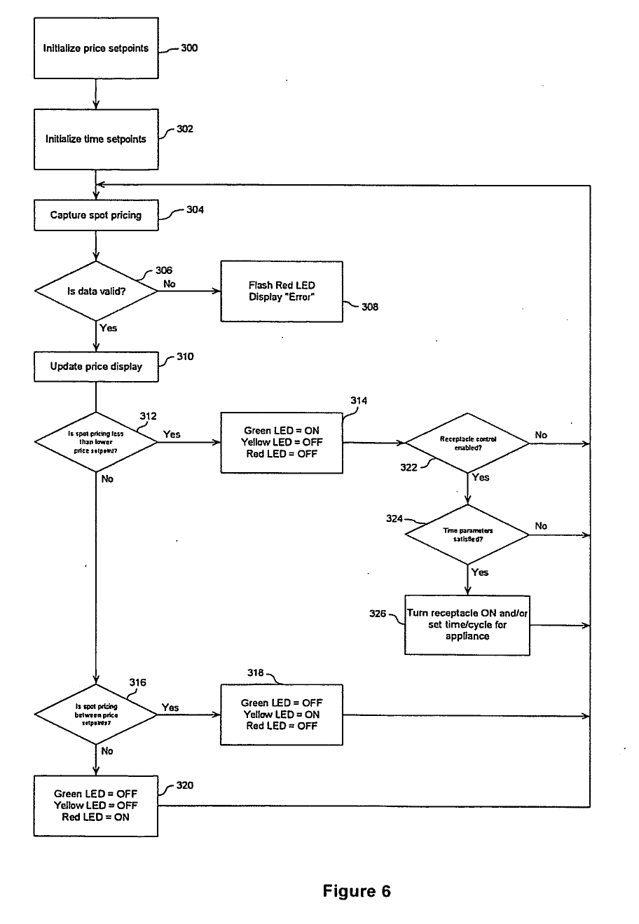

FIG. 6 provides another example, wherein the terminal 22b shown in FIG. 3B is connected to, and thus controls operation of, the appliance 24. In this example, since the appliance 24 is controlled, two criteria are considered, namely price and time, and setpoints established for each. Similar to the example shown in FIG. 5, the setpoints can be programmed by either the consumer 18 or externally using data provided by the supplier 12. The low and high price setpoints are established at step 300 and the time setpoints established at step 302. The time setpoints may provide any number of favourable and non-favourable time criteria such that the consumer 18 can customize the control of the particular appliance 24.

For example, if the consumer 18 wishes to ensure that a dishwasher does not run during meal times, then several non-favourable time periods can be set to coincide with those meal times. The consumer 18 may also set a priority parameter, such that if a particular criterion or set of criteria are met that other criteria are overlooked. For example, if the spot pricing falls below a particular price, this may take priority over the consumer's non-favourable time periods.

At step 304, the terminal 22b begins monitoring electricity prices by capturing spot pricing data from data 16 or 16′. The data is checked for validity at step 306, typically by determining whether or not the price appears to be within a valid range. If the data is invalid then Red LED is set to flash at step 308 which indicates to the consumer 18 that there is something wrong with the data.

Using the touchscreen 50 or digital readout 52, the price is then updated at step 310. Steps 312-320 proceed in a manner similar to steps 208-216 of FIG. 5 and thus need not be reiterated. However, since the terminal 22b is connected to the appliance 24 through receptacle 38, if the price is deemed favourable (e.g. green LED) at step 312, the green LED is switched “on”, and the processor 32 then determines if the receptacle 38 is enabled at step 322. The receptacle 38 may be enabled or disabled by the consumer 18 if desired, which can be controlled using the touchscreen 50. If the receptacle 38 is not enabled, the terminal 22b continues monitoring. If the receptacle 38 is enabled, the time parameters are then evaluated at step 324. The time parameters may include several criteria, and these criteria are evaluated against the current time of day (e.g. maintained by a clock in the processor 32), and if necessary against any priority parameters.

If the time parameters are not satisfied, then the terminal 22b continues monitoring, however, if the time parameters are satisfied, then the receptacle 38 is turned “on” at step 326, and the time/cycle for operation is set for the appliance 24. Therefore, once the pricing data is filtered and updated, the processor 32 may then determine if a connected appliance should be operated. This allows, e.g., the consumer 18 to control the operation of their household appliances while either making an informed decision or enabling the terminal 22b to make an intelligent decision for the purposes of conserving energy without disrupting their daily schedule.

In one embodiment, as discussed above, the terminal 22 may be incorporated into the circuitry of the appliance 24. The circuitry may be part of the existing circuitry or may be retrofitted as an after-market device that can be installed in the appliance 24. In the above example, the dishwasher would preferably provide an external indicator that would provide information regarding why the dishwasher should not run at a particular time (e.g. due to prohibitive pricing). Alternatively, no display 34 is provided and the appliance 24 operates automatically, and is transparent to the consumer 18. Therefore, the terminal 22 may be implemented in any number of suitable ways depending on the particular appliance 24 and the level of transparency desired.

Preferably, as mentioned above, if visible, the terminal 22 is installed in a convenient location in the residence 29, which may or may not be dictated by the consumer 18. The terminal 22 may also form part of a personal computer as software (not shown) or a more extensive “smart home” system. The terminal 22 is also preferably designed to have an ergonomic human interface, as well as taking aesthetics into consideration, to blend in with the consumer's home decor. The terminal 22 will therefore provide a convenient, intelligent and thus useful device so as to enable the consumer 18 to take advantage of favourable spot pricing offered by the supplier 12.

Although the invention has been described with reference to certain specific embodiments, various modifications thereof will be apparent to those skilled in the art without departing from the spirit and scope of the invention as outlined in the claims appended hereto.

What is claimed is:

1. A display terminal for providing electricity pricing information to a consumer, said terminal comprising:
a receiver for receiving data transmitted by an electricity supplier pertaining to said pricing information;
a processor for analyzing said pricing information to determine to which one of a plurality of indicators said pricing information pertains; and
a display for displaying said one of said plurality of indicators.

2. A display terminal according to claim I wherein said plurality of indicators each represent a respective price range and wherein said display indicates which price range said pricing information corresponds to, said pricing information comprising a price.

3. A display terminal according to claim 2 comprising a first indicator corresponding to a favourable price range, a second indicator corresponding to a transitional price range and a third indicator corresponding to a prohibitive price range, wherein said processor selects one of said indicators by correlating said price to a particular one of said price ranges.

4. A display terminal according to claim 3 wherein said display includes a first light corresponding to said first indicator, a second light corresponding to said second indicator and a third light corresponding to said third indicator.

5. A display terminal according to claim 1 wherein said display comprises one or more of a series of lights and a screen.

6. A display terminal according to claim 1 further comprising an input device for adjusting values corresponding to said indicators.

7. A display terminal according to claim 1 further comprising a connection to at least one appliance, wherein said processor uses said one of said plurality of indicators to generate an instruction for said appliance to control the operation thereof.

8. A display terminal according to claim 1 embodied in a software program operable with a computing device.

9. A display terminal according to claim 1 wherein said receiver comprises a connection to a smart meter, said smart meter receiving said pricing information from said electricity supplier.

10. A method for providing electricity pricing information to a consumer, said method comprising the steps of:
receiving data transmitted by an electricity supplier pertaining to said pricing information;
analysing said data to determine to which one of a plurality of indicators said pricing information pertains; and
displaying said one of said plurality of indicators.

11. A method according to claim 10 wherein said plurality of indicators each represent a respective price range and wherein said step of displaying comprises indicating which price range said pricing information corresponds to, said pricing information comprising a price.

12. A method according to claim 11 wherein said step of analyzing comprises selecting a first indicator corresponding to a favourable price range if said price is lower than a predetermined low setpoint, selecting a second indicator corresponding to a transitional price range if said price is between or including said low setpoint and a predetermined high setpoint, and selecting a third indicator if said price is higher than said high setpoint.

13. A method according to claim 12 wherein said step of displaying comprises activating a first light if said first indicator is selected, activating a second light if said second indicator is selected, and activating a third light if said third indicator is selected.

14. A method according to claim 11 further comprising the step of assigning said price ranges to respective ones of said plurality of indicators.

15. A method according to claim 10 wherein said step of analyzing comprises determining if said pricing information is valid and if said pricing information is not valid said step of displaying comprises displaying an error signal.

16. A method according to claim 10 further comprising the step of generating an instruction for at least one appliance based on said one of said plurality of indicators to control the operation thereof.

17. A method according to claim 16 wherein prior to said step of generating an instruction, said method comprises the step of entering one or more setting pertaining to said operation of said appliance whereby said instruction instructs said appliance to operate according to said one or more setting.

18. A method according to claim 16 further comprising the step of comparing said pricing information to a predetermined set of rules pertaining to the operation of said appliance and if said rules are satisfied, said appliance operates according to said instruction.

19. A method according to claim 18 wherein said set of rules comprises a rule related to the time of day during which said appliance may operate.
